(19) United States
(12) Patent Application Publication
(10) Pub. No.: US 2026/0358056 A1
(43) Pub. Date: Nov. 12, 2026

(54) GLASS FURNACE

(71) Applicant: SAINT-GOBAIN ISOVER, COURBEVOIE (FR)

(72) Inventor: Philippe DE DIANOUS, COURBEVOIE (FR)

(21) Appl. No.: 19/124,083

(22) PCT Filed: Oct. 24, 2023
(86) PCT No.: PCT/EP2023/079690

§ 371 Date: Apr. 24, 2025

(30) Foreign Application Priority Data
Oct. 25, 2022 (FR) 2211070
Nov. 30, 2022 (FR) 2212582

(51) Int. Cl. F27D 1/02; C03B 5/04; C03B 5/42; F27D 1/00; F27D 1/14

(52) U.S. Cl. CPC F27D 1/024; C03B 5/04; C03B 5/42; F27D 1/0006; F27D 1/004; F27D 1/141

(57) ABSTRACT

The present invention relates to a glass furnace (1) comprising a tank (10) that is surmounted by a side wall (20) and is closed from above by a crown (30), said crown being supported by an external structure (2), characterized in that the crown is composed of a plurality of individual elements (31), each individual element being secured directly to the external structure.

The invention relates to a glass furnace.

### PRIOR ART

The invention relates to a device for melting a vitrifiable material, in particular for use in the production of flat glass, hollow glass or insulating fibers, hereinafter referred to as a glass furnace.

Such a furnace consists of a tank that is surmounted by a superstructure. The tank is the area in which the raw material is melted. The superstructure is a structure placed on the tank to form an enclosed area. This superstructure thus comprises a side wall and a crown closing the furnace from above.

This side wall and this crown are made of masonry, that is they consist of masonry blocks built together, each block being made of a material resistant to high temperatures such as refractory concrete.

The disadvantage of this type of construction is that it is not flexible in its use. In fact, a glass furnace can be open for operation or maintenance purposes, in order to introduce the composition, to replace parts such as electrodes for an electric furnace with immersed electrodes or a burner for a gas furnace or the furnace can be open to take measurements such as measuring the crust thickness.

Moreover, the masonry of the crown implies a significant mass which can limit the size of the furnace.

There is therefore a need for more modular furnaces.

### SUMMARY OF THE INVENTION

The aim of the present invention is to provide a glass furnace that solves the disadvantages of the prior art by being simple and modular.

To this end, the invention relates to a glass furnace comprising a tank that is surmounted by a side wall and closed from above by a crown, said crown being supported by an external structure, characterized in that the crown is composed of a plurality of individual elements, each individual element being secured directly to the external structure.

According to one example, each individual element consists of a block formed by a plate and a coupling head enabling coupling means to attach said individual element to the structure.

According to one example, individual elements of a same line are provided with interlocking means to fit together.

According to one example, the interlocking means comprise complementary surfaces arranged on the edge of said plates.

According to one example, the coupling means comprise a clip griping the coupling head, said clip being secured to a rod secured to the structure.

According to one example, the footprint of the furnace extends in two perpendicular directions and in which the individual elements are aligned along the shorter direction.

According to one example, the individual elements of two adjacent lines are not aligned.

According to one example, the individual elements have identical dimensions.

According to one example, the side wall comprises a series of panels at least one of which is mobile pivotably mounted.

According to one example, said mobile panel comprises a frame associated with a heat-resistant material, said panel being associated with a pulley system.

According to one example, the individual elements are made of refractory materials.

According to one example, the crown further comprises sealing means comprising tiles arranged on the individual units above the space between two individual elements.

According to one example, the individual elements of the crown are grouped into zones, adjacent zones are free therebetween and wherein the spaces between individual elements of a zone are joined.

### DESCRIPTION OF THE FIGURES

Other particular features and advantages will become clear from the following description thereof, given by way of indication and in an entirely non-limiting manner, with reference to the appended drawings, in which:

FIG. 1 depicts a cross-section of a furnace;

FIG. 2 depicts a cross-sectional view of a crown of a furnace according to the invention;

FIGS. 3 and 4 depict a cross-sectional view of an individual element and its attachment to an external structure of a furnace according to the invention;

FIGS. 5, 6, 12 and 13 depict a variant of an individual element with sides provided with complementary surfaces and a series of such individual elements;

FIGS. 7 and 8 depict different arrangements of the individual elements;

FIG. 9 depicts a cross-sectional view of individual elements, some of which are joined by mortar

FIGS. 10a and 10b depict different views of a mobile panel according to the invention;

FIGS. 11a, 11b and 11c depict cross-sectional views of different variants of a mobile panel according to the invention;

### DETAILED DESCRIPTION OF THE INVENTION

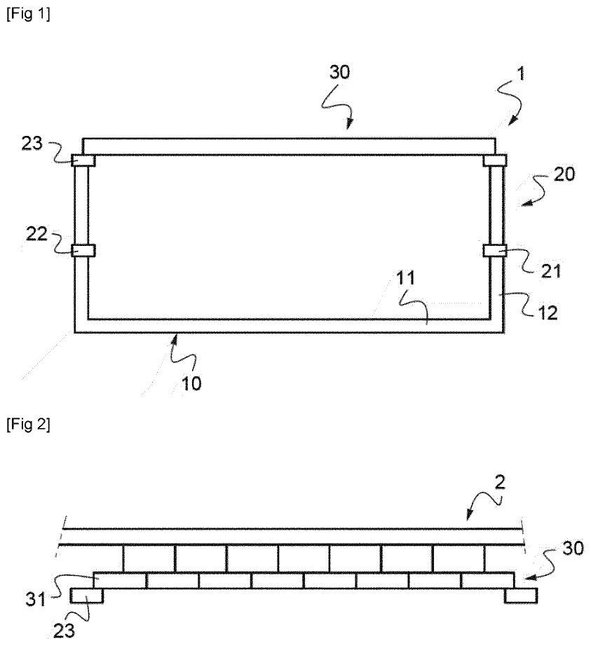

The invention depicted in FIG. 1 relates to a glass furnace 1. Such a glass furnace comprises a tank 10 in which the raw material is melted. This tank 10 has a footprint extending along two perpendicular directions. The tank is thus square or rectangular in shape. This tank is formed of a base 11 and vertical walls 12, each made of layers of materials resistant to the temperatures of the molten raw material such as refractory materials like concrete. These refractory materials can be sintered or electromelted.

The furnace further comprises a side wall 20 surmounting this tank. This side wall is in contact with a tank extension 21 acting as a stop for said side wall. The side wall comprises panels 22 and inserts, these inserts allowing the placement of functional elements such as probes or burners or electrodes or sight holes.

Each panel 22 comprises two parallel faces 22a (internal, external) and a peripheral edge 22b comprising a top portion, a bottom portion and two side portions. The panels and inserts are in contact with each other at their edges, and the interface therebetween is insulated by a flexible, heat-resistant material with low gas permeability.

The side wall is then surmounted by a cornice 23. Finally, the furnace is closed from above by a crown 30 in contact with the cornice 23.

The furnace further comprises an inlet opening through which the raw material is fed and an outlet through which the molten material exits.

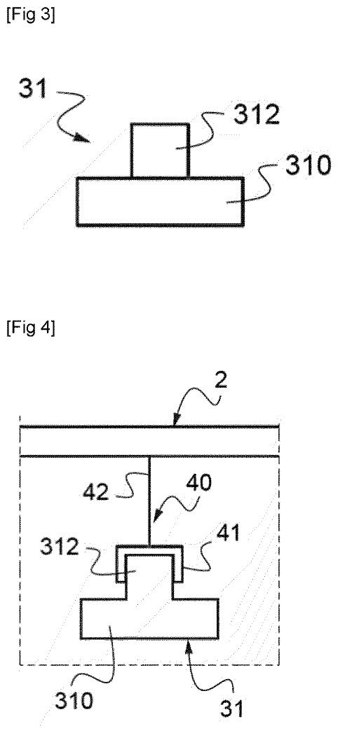

According to the invention, the crown 30 allows a modular and simplified construction as shown in FIG. 2. To achieve this, the crown 30 is composed of individual elements 31 assembled together. These individual elements 31 are suspended from an external structure 2. This external structure 2 may comprise at least one metal beam extending above said crown 30. Each individual element 31 takes the form of a block. The individual elements are made of refractory materials.

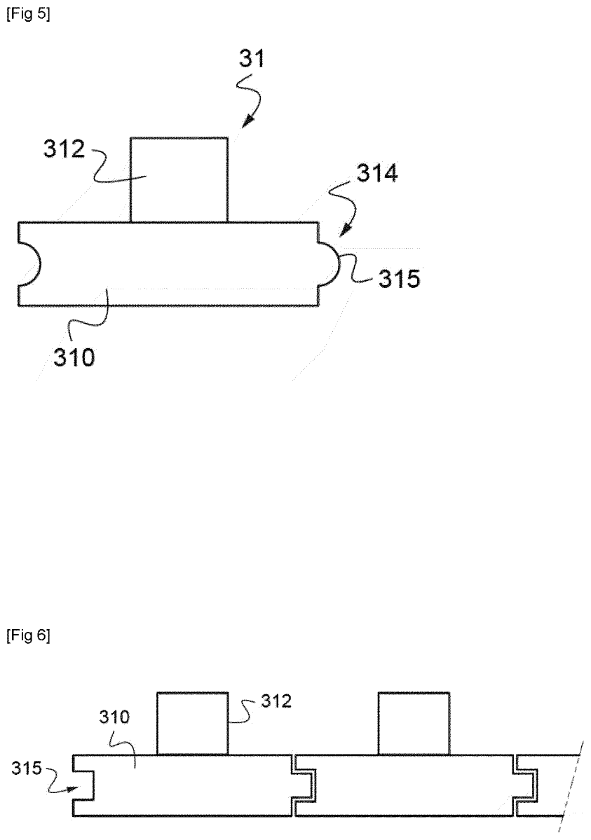

Each individual element 31 comprises a first part and a second part as shown in FIG. 3. The first part takes the form of a plate 310 and is used to form the bottom surface of the crown. The second part is used to attach the individual elements to the external structure. This second part is in the form of a coupling head 312. The coupling head 312 is integral with the plate 310, preferably of the same material as said plate 310. In the case of a coupling head made of the same material as the plate 310, the coupling head and the plate 310 are molded together. Preferably, the coupling head 312 is centered on the plate with respect to at least one axis. The coupling head 312 allows coupling means 40 to attach said individual element to the external structure 2 as can be seen in FIG. 4. These coupling means 40 comprise a clip 41 which grips the coupling head. The coupling head 312 and the clip 41 are shaped to enable said clip to support the coupling head. For example, the coupling head has a spherical cross-section and the clip comprises two curved arms. In the case of a spherical coupling head, it is then possible to give the individual element a slight inclination. This makes it possible to give the crown a curvature or to help with the placement of individual elements.

One advantage of having an individual element comprising a first part and a second part is that the functions can be dissociated. In fact, the individual element according to the invention has a first part which is used as a structuring element of the crown while the second part is dedicated to coupling said individual element. Thus, the use of coupling means 40 coupled to the second part in the form of coupling head 312 by screwing would not result in a loss of performance of the individual element, which would require compensation such as an increase in the thickness of the individual element.

This clip 41 is secured to the end of a rod 42, which is itself secured to the external structure 2. This attachment is for example achieved by bolting. It is understood that each individual element 31 is suspended independently from the external structure 2. This makes it possible to ensure optimum support and to withstand the breakage of a clip on an individual element without affecting the crown. This also gives greater flexibility/adaptability to the assembly, as the rods compensate for possible misalignment of the heads in relation to the coupling holes on the external structure 2.

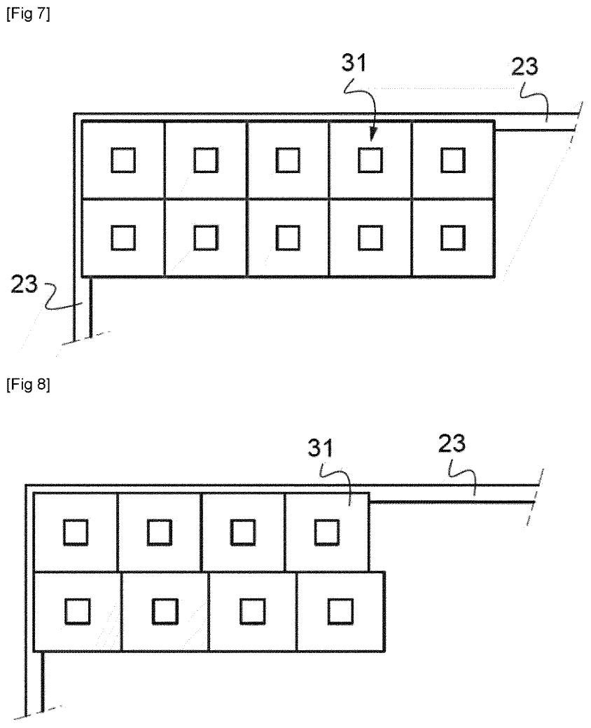

The plate 310 of the first part is such that its surface is that of a quadrilateral of the square or rectangle type with dimensions of 20 to 80 cm on a side and a thickness of 15 to 30 cm. This plate is ingenious in that it has, on at least two sides, interlocking means 314 as can be seen in FIG. 5. These interlocking means 314 take the form of two complementary surfaces 315 of the male (M)-female (F) type, such as for example a hollow and a semicircle (or convex concave) which join together. Each plate thus comprises, on a first side, a first complementary surface and on the opposite side, a second complementary surface. This allows the plates to be combined in order to align them as can be seen in FIG. 6. A refractory type I material is placed between the plates. The complementary surfaces of the same plate can be arranged on opposite sides.

The plates 310 can then comprise a complementary male type surface and a complementary female type surface, arranged on opposite sides.

Preferably, the four sides of a plate 310 are provided with complementary surfaces 315, which may or may not be arranged oppositely. It is understood that the complementary 315 male M and female F surfaces can be arranged on adjacent or opposite sides.

These complementary surfaces 315 enable the individual elements 31 to fit together and therefore provide the crown with good mechanical cohesion. The complementary surfaces 315 are arranged so that a gap remains between the plates of two assembled individual elements 31. This space is used as an expansion joint, that is to compensate for the expansion of individual elements under the effect of heat. To seal the crown 30, tiles 33 or sealing means are arranged on the plates 310 above the space between two plates 310 as can be seen in FIG. 13. These spaces are filled with heat-resistant compressible material (ordinary fibers), these joints closing as the crown expands. The spaces between the individual elements are not all the same.

Complementary surfaces 315 also reduce the risk of fumes passing through.

The complementary surfaces can be arranged to allow a degree of freedom in the positioning of the individual elements, that is to say allow an angular offset between two individual elements.

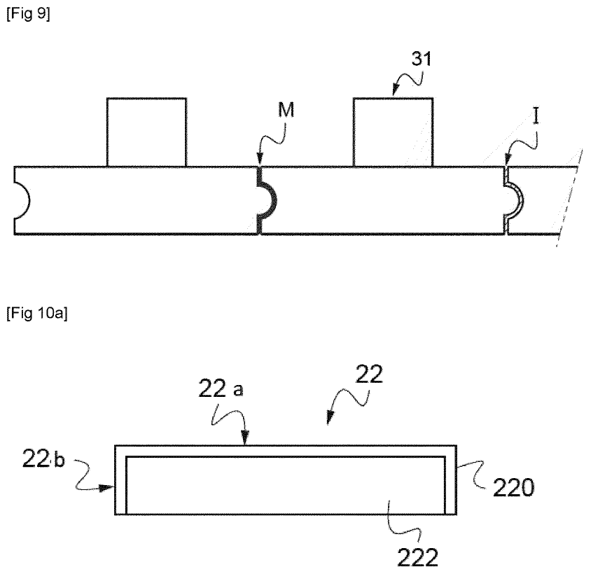

The plates 310 are arranged in an alignment along at least one of the directions of the furnace, that is along the width or length as can be seen in FIG. 7. Thus, the crown 30 is composed of several parallel lines extending in one of the directions of the furnace, preferably the shortest.

According to one preference, the plates 310 of the different lines are aligned. Alternatively to this variant, the plates 310 of the individual elements 30 comprise complementary surfaces of the same type. This means that the plate 310 comprises only complementary male or female type surfaces. This alternative is possible for plates comprising complementary surfaces on two opposite sides or on the four sides. In this case, the individual elements are alternated, that is an individual element provided with complementary male surfaces is only adjacent to individual elements provided with complementary female surfaces.

Of course, the arrangement of complementary surfaces is not limited to the previously described configurations. In fact, it is possible to have very specific configurations with a crown comprising individual elements of several types. This means that the crown can comprise individual elements 31 provided with complementary 315 male M or female F surfaces, or with a mixture of complementary male or female surfaces, these being arranged side by side or on opposite sides. Furthermore, it is also possible for this crown to be provided with individual elements 31 having the same complementary surface on three sides, as can be seen in FIG. 12. According to another preference, the plates 310 of two contiguous lines are offset as can be seen in FIG. 8. Indeed, one solution consists of seeing the plates aligned in both directions. In this case, the plates thus form a checkerboard in which four plates meet at one point. This offset can be achieved by using plates having identical dimensions or with identical plates but with a portion of the plates at the beginning of the line.

In one variant, the plates are grouped together in the form of joined modules.

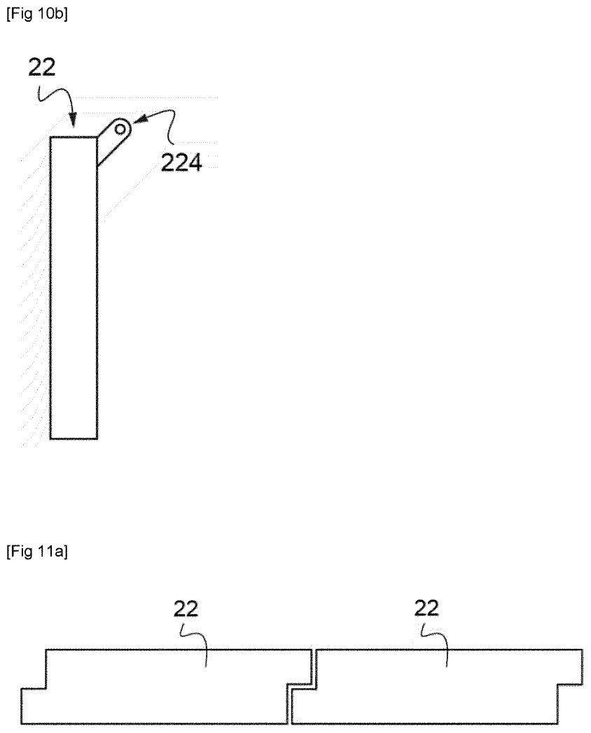

To reinforce the crown, a certain number of plates 310 can be joined with mortar M instead of using a tile above the gap between two plates. This mortar is placed, between two plates, on the sides bearing the complementary surfaces or on other sides as can be seen in FIG. 9. This mortar reinforces the solidity of the crown and prevents gas infiltration between plates.

To manage the overall expansion of the crown during tempering, the mortar is placed to form modules or zones, which are separated by open joints or filled with heat-resistant compressible material (ordinary fibers), these joints closing as the crown expands. The individual elements of the crown are then grouped into zones. The individual elements of a zone are joined together with mortar, while the individual zones are not joined with the adjacent zone(s).

Thus, the combination of mortar with the complementary surfaces reinforces the crown against the infiltration of fumes/composition gases, and therefore maintains a good seal while ensuring good mechanical strength. This good mechanical strength means that the crown is less complex, avoiding the need to superimpose blocks in different layers which would weigh down the crown and require a larger external structure 2.

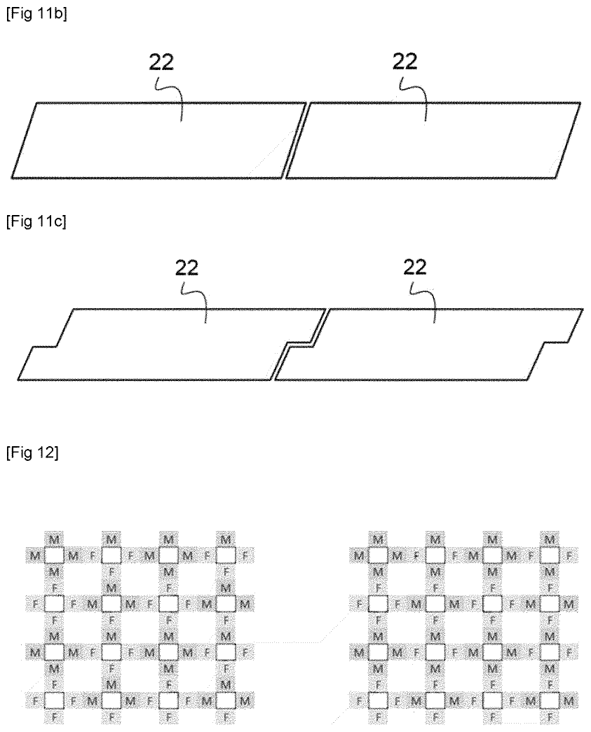

In a variant shown in FIGS. 10a and 10b, the panels 22 forming the side wall are mounted so as to be mobile. More particularly, the panels are pivotably mounted. For this purpose, each panel consists of a metal frame 220 on which a concrete-type heat-resistant material 222 is placed. This material is molded onto this frame to form a plate, the latter being fitted with hooks overmolded with concrete to securely attach said material to the frame. A fiber mat can be interposed between the concrete-like material and the metal frame to protect the metal from the heat of the concrete and to reduce losses through the doors, particularly during tempering. The frame is then provided with two drilled extensions 224 so that a pin can be inserted to make the panel pivoting. A pulley system is used to pivot the panel. This ability to pivot the panel(s) simplifies furnace maintenance, e.g. replacing electrodes or passing a measuring tool through.

Panels on the same face of the side wall can be arranged to pivot simultaneously. For this purpose, they can be joined together by a metal beam connected to the pulley system or to the pulley systems.

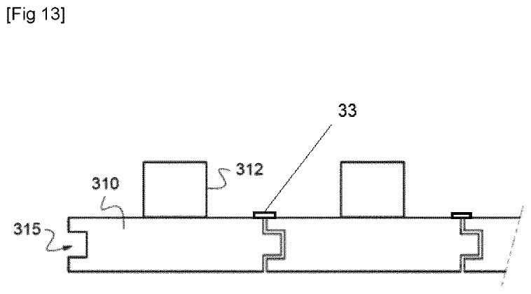

In a particular embodiment of these panels, one or more lateral portions of the peripheral edge 22b is not perpendicular to the external face of said panel. This lateral portion may be angled and/or have a stepped profile as can be seen in FIGS. 11 a, 11 b and 11 c. A stepped profile consists of a profile having a notch. The lateral portion can combine an angle and a notch.

Thus, two adjacent panels are arranged so that their contacting side portions are complementary.

Of course, the present invention is not limited to the illustrated example but is susceptible to various variants and modifications which will become apparent to the person skilled in the art.

As such, the furnace also comprises circular openings in the crown to introduce cullet in the event of poor operation (tempering, hot crown, batch feeder failure).

In addition, complementary surfaces with different geometries can be provided. More particularly, the complementary surfaces of the plates along a first direction can have a convex concave geometry and along a second direction a crenelated or triangular geometry. These different complementary surfaces can be arranged on opposite or adjacent sides.

1. A glass furnace comprising a tank surmounted by a side wall and closed from above by a crown, said crown being supported by an external structure, wherein the crown is composed of a plurality of individual elements each individual element being secured directly to the external structure.

2. The furnace according to the claim 1, wherein each individual element consists of a block formed by a plate having a quadrilateral shape and a coupling head enabling coupling means to attach said individual element to the structure.

3. The furnace according to claim 2, wherein the individual elements of the a same line are provided with interlocking means for interlocking with one another.

4. The furnace according to the claim 3, wherein the interlocking means comprise complementary surfaces of the male female type arranged on the edge of said plates.

5. The furnace according to claim 2, wherein the coupling means comprise a clip griping the coupling head said clip being secured to a rod secured to the structure.

6. The furnace according to claim 1, wherein a footprint of the furnace extends in two perpendicular directions and wherein the individual elements of the crown are aligned in the shorter direction.

7. The furnace according to claim 6, wherein the individual elements of two contiguous lines are not aligned.

8. The furnace according to claim 1, wherein the individual elements have identical dimensions.

9. The furnace according to claim 4, wherein each plate comprises two complementary surfaces.

10. The furnace according to claim 4, wherein each plate comprises four complementary surfaces.

11. The furnace according to claim 9, wherein the two complementary surfaces are on opposite sides.

12. The furnace according to claim 10, wherein the plate comprises two pairs of opposite complementary surfaces in pairs.

13. The furnace according to claim 1, wherein the side wall comprises a series of panels at least one of which is mobile pivotably mounted.

14. The furnace according to claim 13, wherein said mobile panel comprises a frame associated with a heat-resistant material, said panel being associated with a pulley system.

15. The furnace according to claim 1, wherein the individual elements are made of refractory materials.

16. The furnace according to claim 1, wherein the crown further comprises sealing means comprising tiles arranged on the individual elements above the space between two individual elements

17. The furnace according to claim 1, wherein the individual elements of the crown are grouped into zones, adjacent zones are free therebetween and wherein the spaces between individual elements of a zone are joined.
